(19) United States
(12) Patent Application Publication
(10) Pub. No.: US 2014/0012613 A1
(43) Pub. Date: Jan. 9, 2014

(54) SYSTEM AND METHOD FOR MANAGING THIRD-PARTY LABOR

(71) Applicants: David Diamond, New York, NY (US); Timothy J. Hawkes, Westport, CT (US)

(72) Inventors: David Diamond, New York, NY (US); Timothy J. Hawkes, Westport, CT (US)

(73) Assignee: STOREPORT RETAIL SERVICES, INC., Westport, CT (US)

(21) Appl. No.: 13/827,889

(22) Filed: Mar. 14, 2013

Related U.S. Application Data
(60) Provisional application No. 61/668,050, filed on Jul. 5, 2012.

(51) Int. Cl. G06Q 10/06

(52) U.S. Cl. CPC G06Q 10/06311
USPC 705/7.13

(57) ABSTRACT

A system. The system includes a computing device, an authentication module, an instruction module and a tracking module. The computing device includes a processor. The authentication module is communicably connected to the processor and is configured to authenticate that a person is associated with a third-party associated with a store. The instruction module is communicably connected to the processor and is configured to coordinate work instructions to be completed at the store. The tracking module is communicably connected to the processor and is configured to track information associated with the person.

### CROSS-REFERENCE TO RELATED APPLICATION

This application claims the benefit under 35 U.S.C. §119(e) of the earlier filing date of U.S. Provisional Patent Application No. 61/668,050 filed on Jul. 5, 2012.

### BACKGROUND

This application discloses an invention which is related, generally and in various embodiments, to a system and method for managing third-party labor.

In years past, the vast majority of labor required to operate an exemplary retail store was performed by employees of the retail store. However, due to a variety of factors, over the past few decades more and more of the labor activities associated with a retail store (e.g., resetting the shelves, building displays, handing out free samples, waxing the floors, cleaning the windows, servicing the refrigeration equipment, providing security services, etc.) are now being performed by parties other than the employees of the retail store. Such third-parties can include, for example, independent contractors paid by the retailer, employees of manufacturers of products sold in the retail store, independent contractors paid by the manufacturers, etc. The labor activities performed by the third-parties can be complicated and can involve multiple parties.

As the retail store has emerged as a powerful marketing and advertising medium, manufacturers of consumer packaged goods (CPG) are managing more and more of their in-store execution. According to some estimates, the manufacturers/brands now spend over two billion dollars each year to manage their merchandising presence and implement tactical promotional programs in retail stores. An ongoing concern for both the manufacturers/brands and the retailers is the significant amount of dollars mis-spent and incurred in opportunity costs due to poorly executed merchandising programs. For example, it has been estimated that approximately 50% of authorized retail promotional displays are either erected late or not at all.

The manufacturers/brands have been outsourcing more and more of their in-store labor activities to sales and marketing agencies (SMAs) and other third-party manpower suppliers. Although the outsourcing of sales, marketing and merchandising responsibilities are financially desirable in many cases, the outsourcing results in the manufacturers/brands frequently sacrificing a significant level of executional control and reporting transparency.

Retailers and manufacturers/brands are rapidly adopting shopper marketing as a core consumer marketing strategy. As the store increasingly becomes the primary communications medium for shopper marketing programs, the need for satisfactory in-store execution increases in importance.

Unfortunately, the systems which are currently used by retailers to manage their in-store labor costs have not been effective for managing third-party labor costs, and manufacturers/brands who hire the in-store labor have been unable to effectively manage the in-store execution.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of an in-store computing system communicably connected to the system of FIG. 1;

FIG. 3 illustrates various embodiments of a computing system of the system of FIG. 1;

FIGS. 4-13 are exemplary screen shots of exemplary user interfaces associated with the system of FIG. 1; and

FIG. 14 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

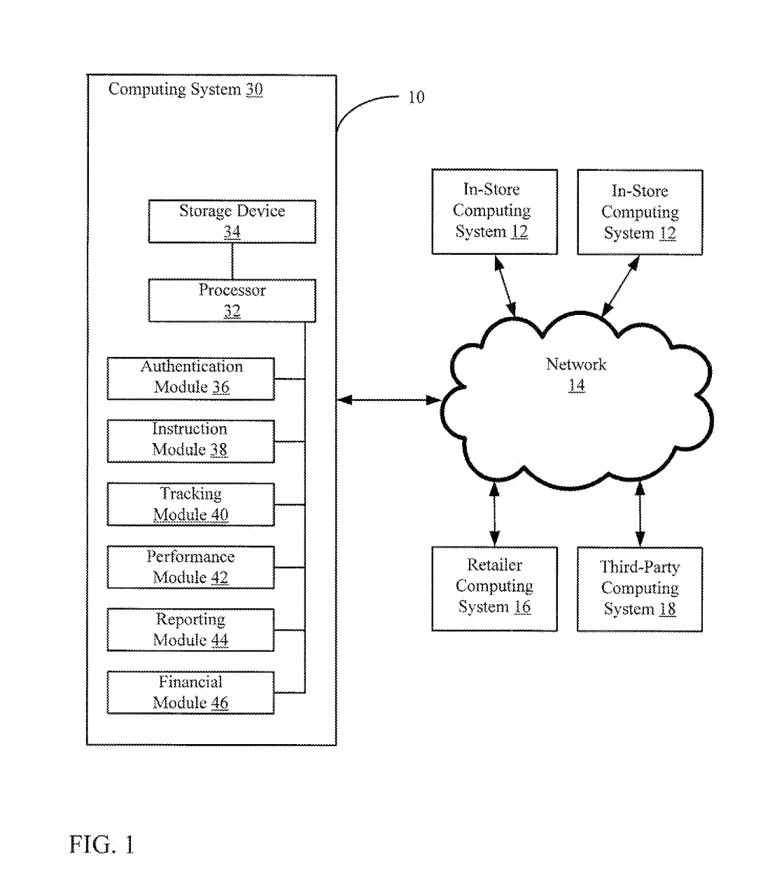

FIG. 1 illustrates various embodiments of a system 10. The system 10 is configured to manage third-party labor. For purposes of simplicity, the system 10 will be described in the context of the management of third-party labor in one or more retail stores. However, it will be appreciated that the system 10 may be utilized to manage any type of third-party labor in any type of environment.

The system 10 may be communicably connected to a plurality of in-store computing systems 12 via one or more networks 14. The system 10 may also be communicably connected to a plurality of retailer computing systems 16 and to a plurality of one or more third-party computing systems 18. For purposes of simplicity, only one in-store computing system 12, one retailer computing system 16 and one third party computing system 18 is shown in FIG. 1. However, it will be appreciated that the system 10 may be communicably connected to any number of in-store computing systems 12 (e.g., one at each store of a given retailer), any number of retailer computing systems 16 and any number of third party computing systems 18. A given retailer computing system 16 may be the computing system for any number of different types of retailers. For example, a given retailer computing system 16 may be the computing system for a grocer (e.g., Kroger, Costco, SuperValu, Safeway, Publix), for a drug store (e.g., CVS, Rite Aid, Walgreens), for a mass merchandiser (e.g.,Wal-Mart, Target, Kmart), etc. Similarly, a given third-party computing system 18 may be the computing system for any number of different third-parties who supply and/or manage in-store labor. For example, a given third-party computing system 18 may be the computing system for a consumer packaged goods marketer, a sales and marketing agency, a custodial service company, an equipment maintenance company, a security company, etc.

Each of the one or more networks 14 may include any type of delivery system including, but not limited to, a local area network (e.g., Ethernet), a wide area network (e.g. the Internet and/or World Wide Web), a telephone network (e.g., analog, digital, wired, wireless, fiber optic, PSTN, ISDN, GSM, GPRS, and/or xDSL), a packet-switched network, a radio network, a television network, a cable network, a satellite network, and/or any other wired or wireless communications network configured to carry data. A given network 14 may include elements, such as, for example, intermediate nodes, proxy servers, routers, switches, and adapters configured to direct and/or deliver data. In general, the system 10 may be structured and arranged to communicate with the computing systems 12, 16, 18 via the one or more networks 14 using various communication protocols (e.g., HTTP, HTTPS, TCP/IP, UDP, WAP, WiFi, Bluetooth) and/or to operate within or in concert with one or more other communications systems.

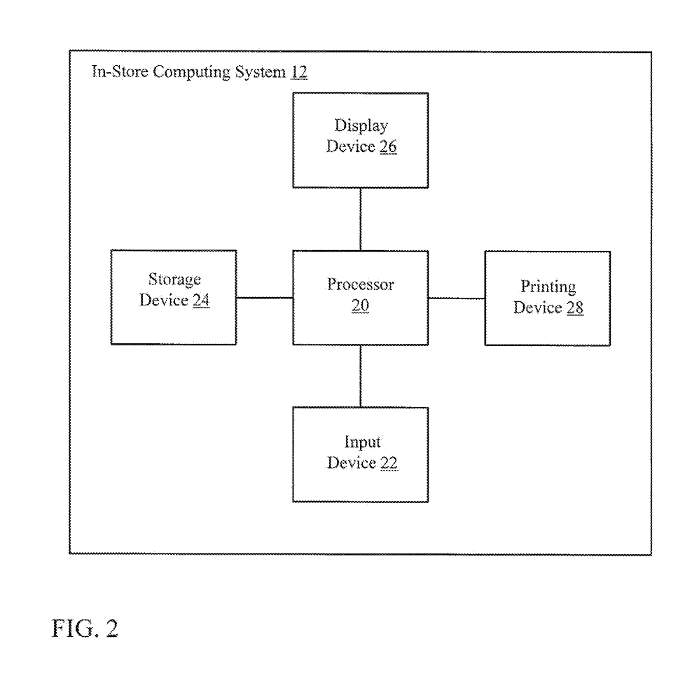

FIG. 2 illustrates various embodiments of the in-store computing system 12. The in-store computing system 12 is individually addressable and configured for communication with other computer systems. According to various embodiments, the in-store computing system 12 includes one or more processors 20, one or more input devices 22 communicably connected to the processor 20, a storage device 24 communicably connected to the processor 20, and a display device 26 communicably connected to the processor 20. As shown in FIG. 2, the in-store computing system 12 may also be communicably connected to a printing device 28.

Although only one input device 22 is shown in FIG. 2 for purposes of simplicity, it will be appreciated that the in-store computing system 12 may include any number of different input devices 22. For example, according to various embodiments, the in-store computing system 12 includes a card reader input device 22 which utilized by a person (e.g., a third-party laborer) to indicate his arrival and departure from the store by swiping or scanning a unique identification card upon his arrival to and departure from the retail store. The unique identification card may include a magnetic stripe or bar code which is read by the card reader input device 22 to associate the unique identification card with a given third-party laborer. According to other embodiments, the unique identification card may be a proximity card (either an active or passive card) which is read by the card reader input device 22 if the unique identification card is placed in the proximity of the card reader input device 22. According to yet other embodiments, the input device 22 may be a biometric input device, and a person can indicate his arrival and departure from the store by subjecting his fingerprint, iris, retina, etc. to be read by the biometric input device.

According to various embodiments, the in-store computing system 12 may also include one or more input devices 22 such as, for example, a keyboard, an optical scanning device, a touch screen, etc. Such input devices may be utilized to allow a third-party worker to input a list of tasks completed while at the store, the time taken to perform each task, information related to materials purchased to complete the tasks, information related to materials still needed to complete one or more scheduled tasks, etc. Although not shown in FIG. 2 for purposes of simplicity, it will also be appreciated that the in-store computing system 12 may also include one or more USB ports to receive data from an external device, and may also be configured to receive wireless data sent from an external device. Collectively, all of the various input devices 22 and external devices allow for a substantial amount of information to be received by in-store computing system 12, and the in-store computing system 12 may subsequently communicate this information to the system 10 via the one or more networks 14. Additionally, according to various embodiments, employees of the retail store may also utilize the input device 22 to input certain store-level information to the in-store computing system 12 for subsequent communication to the retailer computing system 16.

According to various embodiments, the in-store computing system 12 is also configured to “load” positive or negative sums of money onto the unique identification card. For example, according to various embodiments, the unique identification card may be associated with or linked to a financial account and the system 10 may be utilized to debit or credit amounts to the financial account. Because the in-store computing system 12 is communicably connected to the system 10, the in-store computing system 12 may cooperate with the system 10 to debit or credit the amounts to the unique identification card after the unique identification card is “read” by the input device 22 of the in-store computing system 12.

According to various embodiments, devices other than the in-store computing system 12 may be utilized to provide the above-described functionality associated with the in-store computing system 12. For example, according to various embodiments, the system 10 may generate a random ten-digit number (e.g., a different number every day) for a given store. A device at the store can display the ten-digit number, and a third-party laborer may indicate his arrival at and departure from the given store by entering the ten-digit number into a mobile phone application, then subsequently sending the entered ten-digit code to the computing system 30. According to other embodiments, the system 10 may assign a certain code such as, for example, a set of numbers, a bar code, a quick response code, etc. which can be changed on a periodic basis to a given store. A device at the store can display the assigned code, and a third-party laborer may indicate his arrival at and departure from the given store by scanning the displayed code into a mobile phone application, then subsequently sending the scanned code to the computing system 30. According to yet other embodiments, a mobile phone application may be utilized by a third-party laborer to communicate the geo-location of the mobile phone to the computing system 30 in order to confirm that the third-party laborer is at the store.

Returning to FIG. 1, the system 10 includes a computing system 30. The computing system 30 may include any suitable type of computing device (e.g., a server, a desktop, a laptop, etc.) that includes at least one processor 32. Various embodiments of the computing system 30 are described in more detail hereinbelow with respect to FIG. 2.

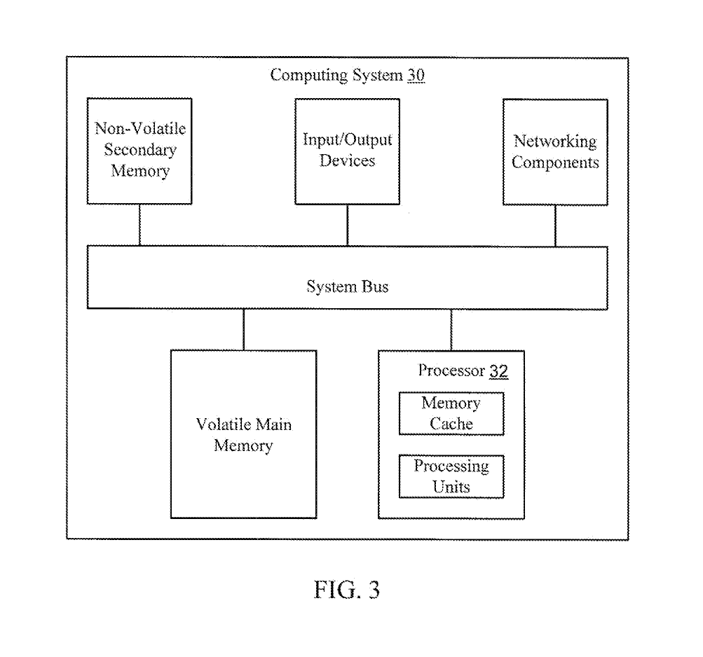

FIG. 3 illustrates various embodiments of the computing system 30. The computing system 30 may be embodied as one or more computing devices, and includes networking components such as Ethernet adapters, non-volatile secondary memory such as magnetic disks, input/output devices such as keyboards and visual displays, volatile main memory, and a processor 32. Each of these components may be communicably connected via a common system bus. The processor 32 includes processing units and on-chip storage devices such as memory caches.

According to various embodiments, the computing system 30 includes one or more modules which are implemented in software, and the software is stored in non-volatile memory devices while not in use. When the software is needed, the software is loaded into volatile main memory. After the software is loaded into volatile main memory, the processor 32 reads software instructions from volatile main memory and performs useful operations by executing sequences of the software instructions on data which is read into the processor 32 from volatile main memory. Upon completion of the useful operations, the processor 32 writes certain data results to volatile main memory.

Returning once again to FIG. 1, according to various embodiments, the system 10 also includes a storage device 34 communicably connected to the processor 32. The storage device 34 stores information communicated to the system 10 from the respective in-store computing systems 12, as well as from the respective retailer computing systems 16 and third-party computing systems 18, and such information may be organized into one or more relational databases. As shown in FIG. 1, the storage device 34 may be integral with the computing system 30. According to other embodiments, the storage device 34 is remote from but communicably connected to the computing system 30. Although only one storage device 34 is shown in FIG. 1, it will be appreciated that the system 10 may include any number of storage devices 34.

According to various embodiments, the system 10 also includes one or more of the following: an authentication module 36, an instruction module 38, a tracking module 40, a performance module 42, a reporting module 44 and a financial module 46. Each of the modules 36-46 are communicably connected to the processor 34 and may be communicably connected to one another.

The authentication module 36 is configured to authenticate that a person is associated with a given third-party service provider. For example, the retailer and/or third-party service providers may provide lists of authorized in-store workers to the system 10 via the retailer computing system 16 and/or one or more of the third-party computing systems 18. Such lists may be stored at storage device 34 and may be arranged by individual worker, by individual retail store, by individual third-party service provider, etc. At a given store, when a third-party worker wishes to be authenticated as an authorized third-party worker, the third-party worker may, for example, swipe a unique identification card through a card reader input device 22 of the in-store computing system 12. The in-store computing system 12 then communicates the information read by the card reader input device 12 to the system 10, where the authentication module 36 compares the received information to information stored at the storage device 34 to determine whether or not to authenticate the person as an authorized third-party worker. It will be appreciated that the information associated with the third-party worker may be read by other types of input devices 22 of the in-store computing system 12 (e.g., a scanner, a biometric reader, etc.)

The instruction module 38 is configured to coordinate work instructions to be completed at a given retail store. For example, for a given retail store, the system 10 may receive work instructions to be completed at the store from one of the retailer computing systems 16 and/or one or more of the third-party computing systems 18. The instruction module 38 organizes all of the received instructions so that they can be presented to an associated third-party laborer by, for example, the display device 26 of the in-store computing system 12 shortly after the third-party laborer is authenticated by the authentication module 36. According to various embodiments, the instructions may be communicated to the printing device 28 so that a hard copy of the instructions can be provided to the third-party worker.

The tracking module 40 is configured to track information associated with the third-party laborers who perform tasks in one or more retail stores for one or more manufacturers, brands, and/or service companies. Such information may include, for example, (1) the time when a given third-party laborer checked into and/or out of a given retail store, (2) the time it took the given third party laborer to perform a given task, (3) the number of tasks completed by the given third-party laborer, (4) the in-store costs for materials and/or supplies (non-labor costs) attributable to the completion of a given task, etc. The information tracked by the tracking module 40, which includes the performance of the third-party laborers, is based on information received from the respective in-store computing systems 12. The information may be tracked by company, by individual, by location, by time of day, etc.

The performance module 42 is configured to determine the performance metrics of the various third-party workers. For example, for a given retail store, the system 10 may receive target performance metrics for the store from one of the retailer computing systems 16 and/or one or more of the third-party computing systems 18. The performance module 42 compares the performance of the respective third-party laborers with the target performance metrics received from the retailer computing systems 16 and/or one or more of the third-party computing systems 18 to determine the performance metrics of the third-party laborers. Once the performance metrics of the third-party laborers are determined by the performance module 42, the tracking module 40 may track the performance metrics of the third-party laborers.

The reporting module 44 is configured to analyze the information stored at the storage device 34 to prepare reports which can be communicated to and/or accessed by the respective retailers and/or third-party service providers. Such reports can provide valuable insight regarding information related to time, attendance, staffing levels, store characteristics, store visits, etc., as well as to analyses related to service levels, costs, benchmarks, return-on-investment, etc.

The financial module 46 is configured to determine an amount of revenue to be paid by a user of the system 10. For example, according to various embodiments, a proprietor of the system 10 may be contractually entitled to receive a predetermined amount each time a third-party laborer utilizes an in-store computing system 12 to indicate his arrival and/or departure from a given retail store. Additionally, the proprietor of the system 10 may be contractually entitled to receive a predetermined amount each time a store employee utilizes the input device 22 to provide certain store-level information to the in-store computing system 12, or each time a given retailer and/or third-party service provider communicate other information (e.g., tasks to be completed, target performance metrics, etc.) to the system 10.

According to various embodiments, the financial module 46 is also configured to add positive or negative sums of money to a financial account associated with or linked to a unique identification card. Such sums may be added to the financial account based on a request the system 10 receives from the retailer computing system 16 and/or the third-party computing system 18. Once such sums are added to the financial account, a third-party laborer may utilize the unique identification card at one or more respective stores to purchases products needed for in-store execution. According to various embodiments, such purchases may be initiated via the in-store computing system 12 or at a standard check-out register.

The modules 36-46 may be implemented in hardware, firmware, software and combinations thereof. For embodiments utilizing software, the software may utilize any suitable computer language (e.g., C, C++, C#, Perl, Java, JavaScript, Visual Basic, VBScript, Delphi) and may be embodied permanently or temporarily in any type of machine, component, physical or virtual equipment, storage medium, or propagated signal capable of delivering instructions to a device. The modules 36-46 (e.g., software application, computer program) may be stored on a computer-readable medium (e.g., disk, device, and/or propagated signal) such that when a computer reads the medium, the functions described herein-above are performed. According to various embodiments, the above-described functionality of the modules 36-46 may be combined into fewer modules, distributed differently amongst the modules, spread over additional modules, etc.

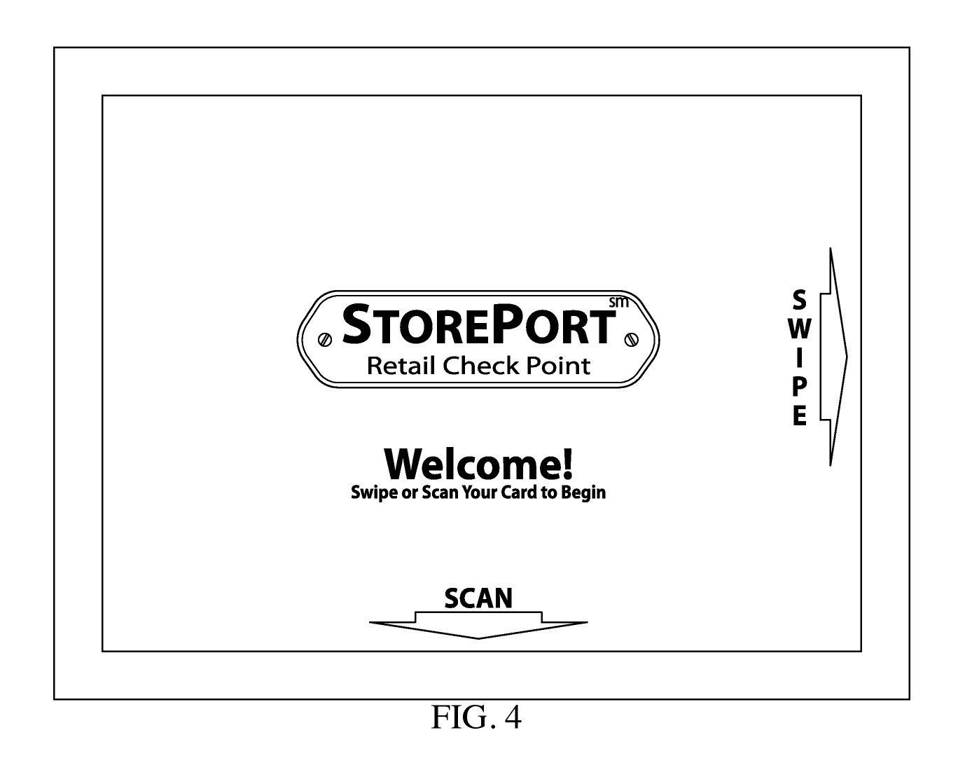

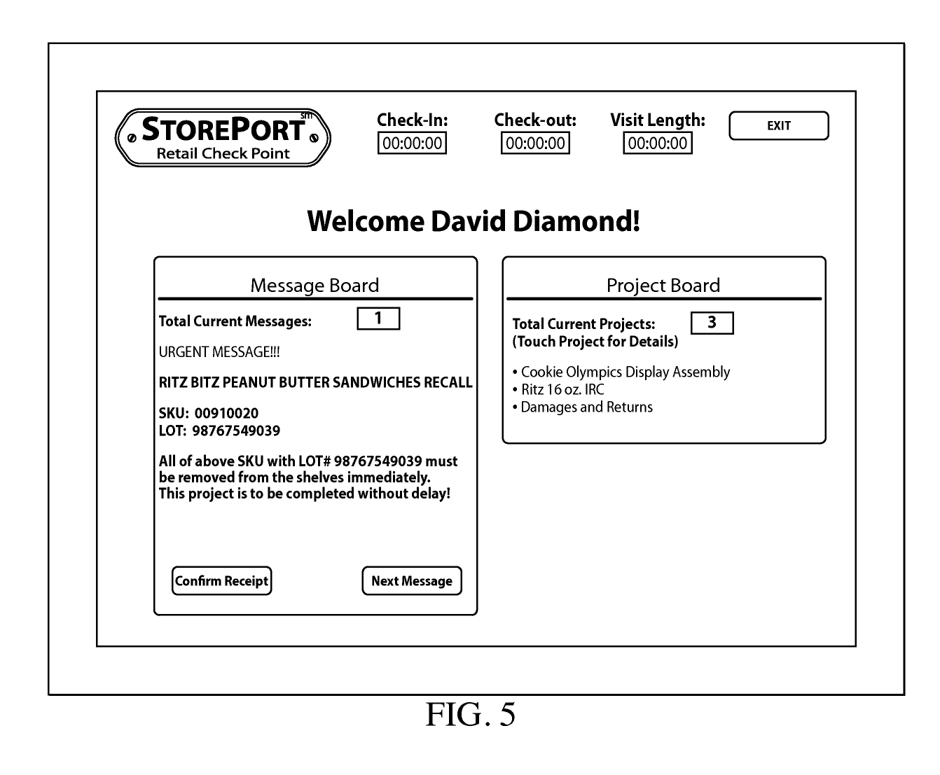

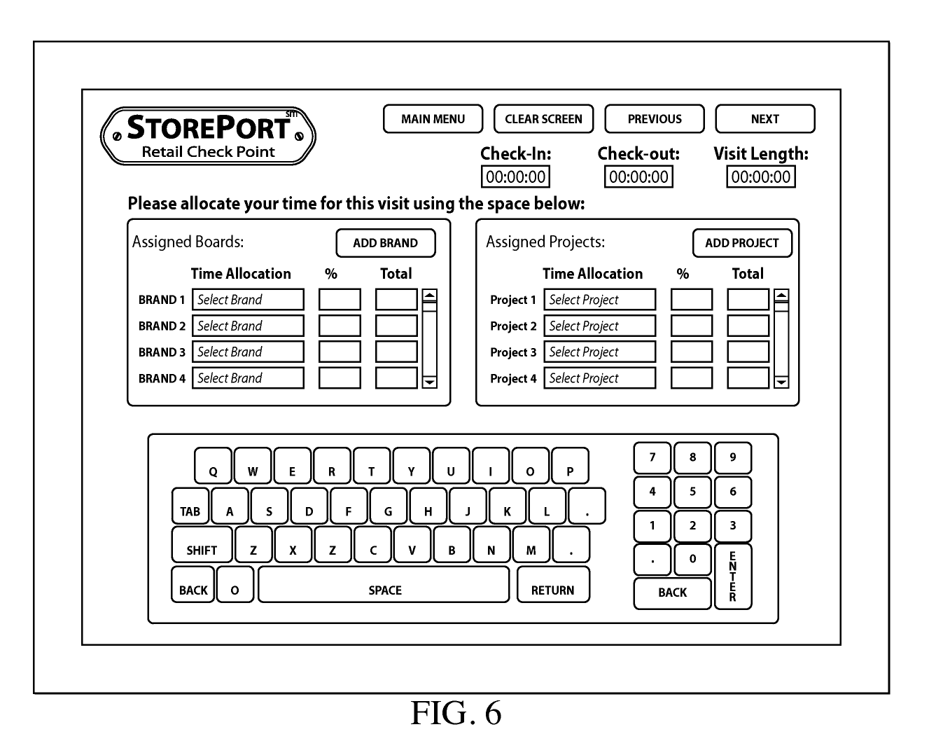

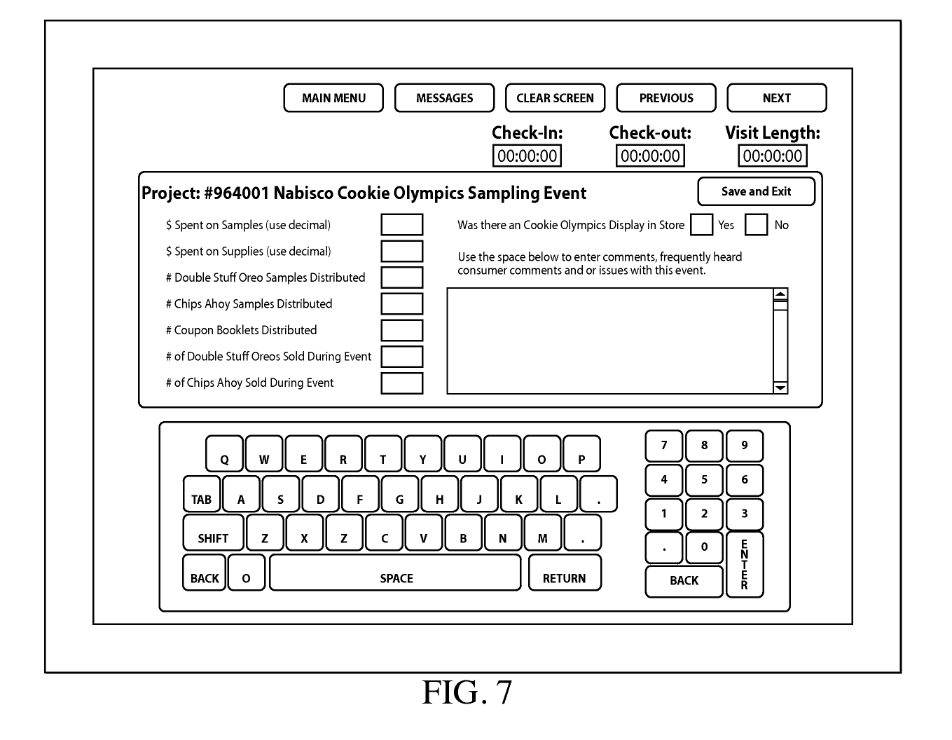

FIGS. 4-7 are exemplary screen shots of an exemplary display device 26 of the in-store computing system 12. FIG. 4 shows a welcome page at an in-store checkpoint. FIG. 5 shows a time clock and communication portal, with real-time messaging and a live project summary. FIG. 6 shows accounting for time spent, where brokers and MSOs can allocate time to various brands. FIG. 7 shows in-reporting results (e.g., in-store program results).

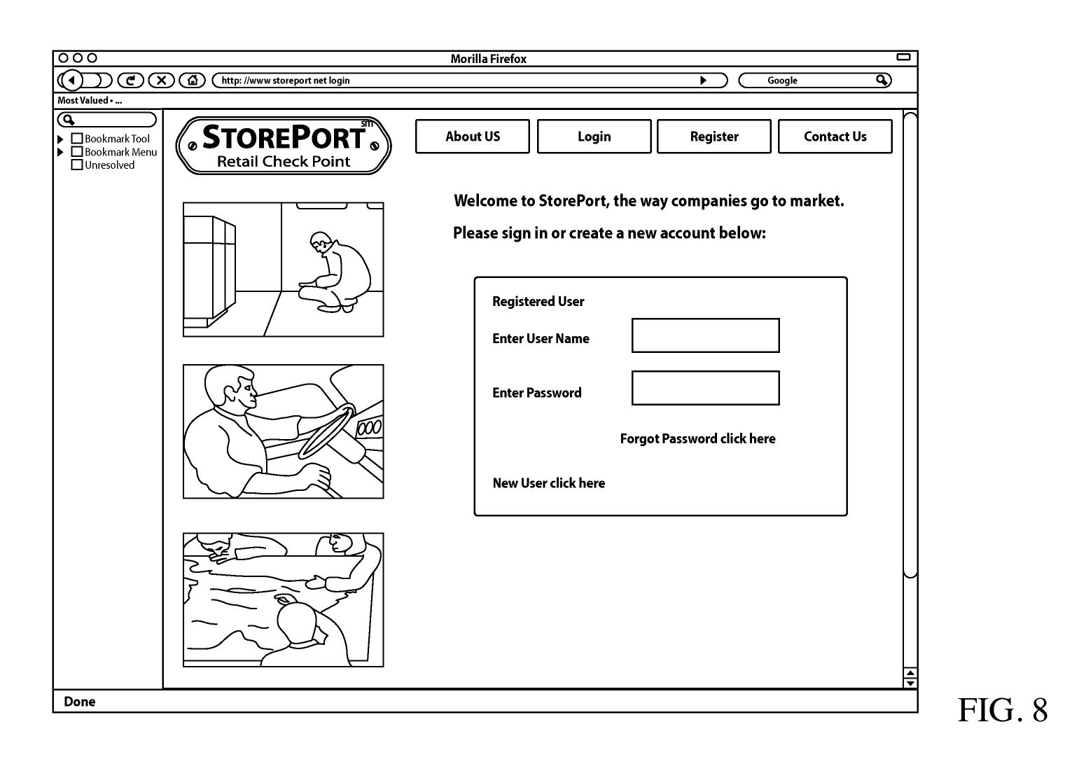

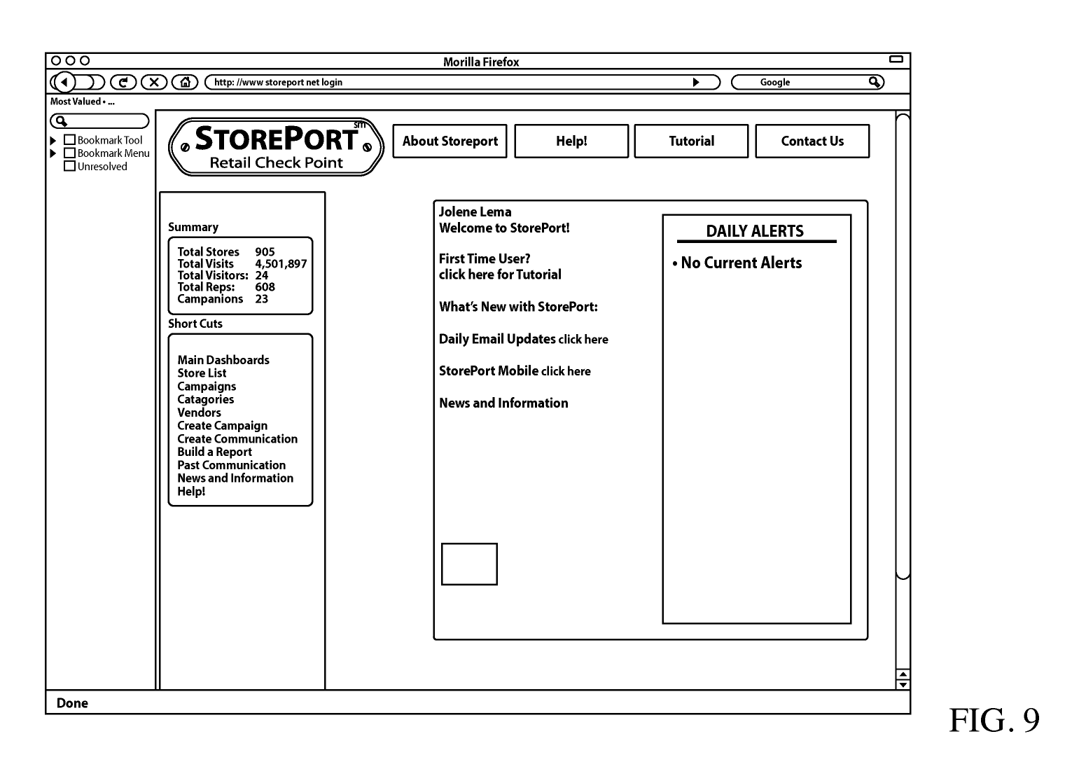

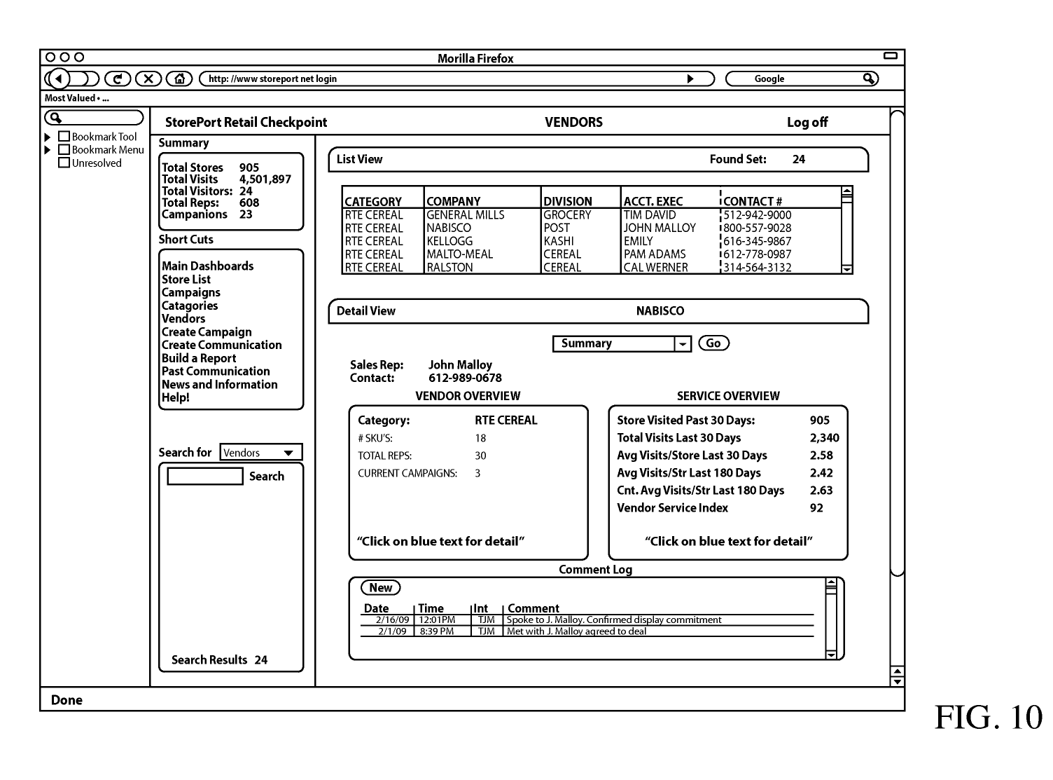

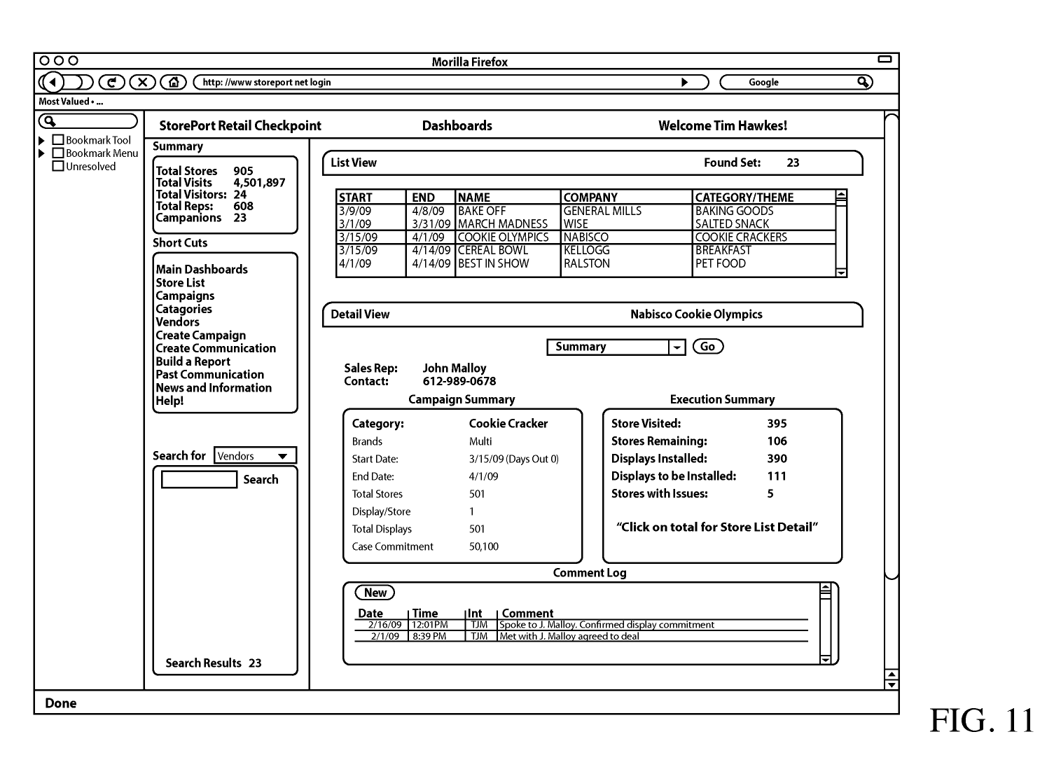

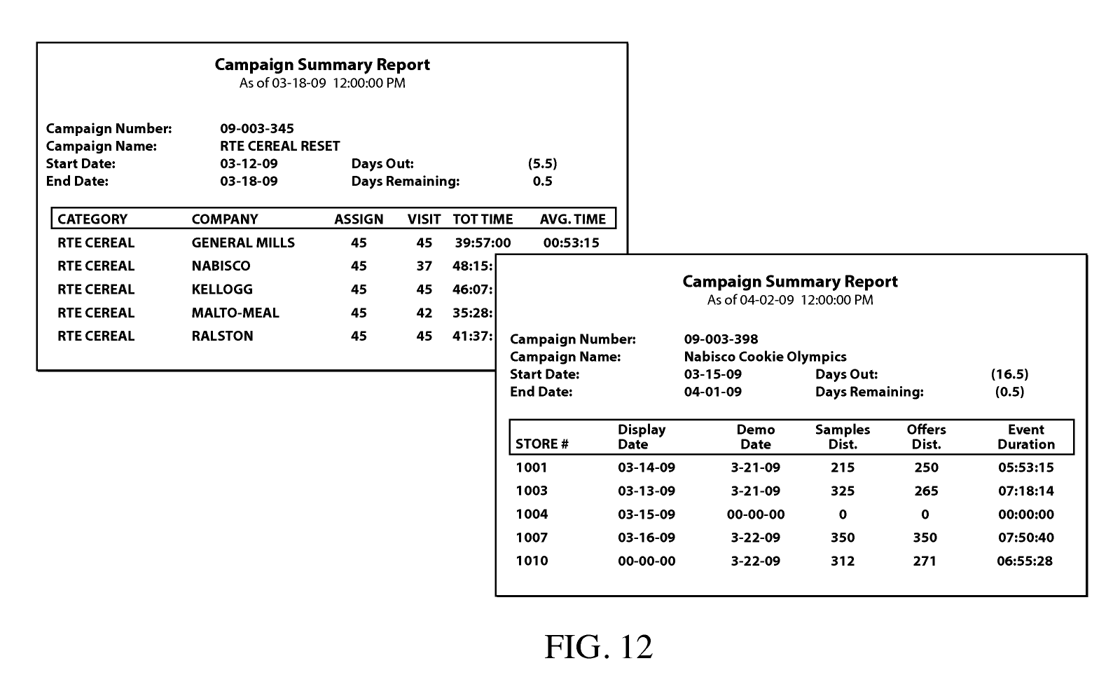

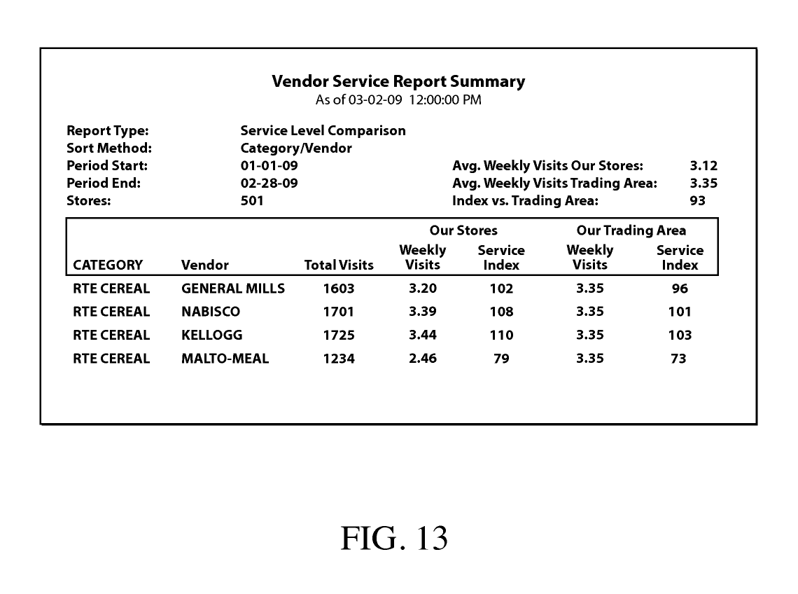

FIGS. 8-13 are exemplary screen shots of exemplary user interfaces of the system 10, the retailer computing system 16 and/or the third-party computing system 18. FIG. 8 shows a retailer dashboard, with password protected access. FIG. 9 shows two-way communication, quick navigation and search shortcuts, and news and information program prompts. FIG. 10 shows real-time tracking, where vendor performance can be tracked. FIG. 11 shows measured results, including the monitoring of in-store program execution and results. FIG. 12 shows a summary report (retailer initiated) and a store detail report (vendor initiated). FIG>13 shows vendor service level tracking, including vendor vs. vendor, vendor vs. trading area and a given store vs. a trading area.

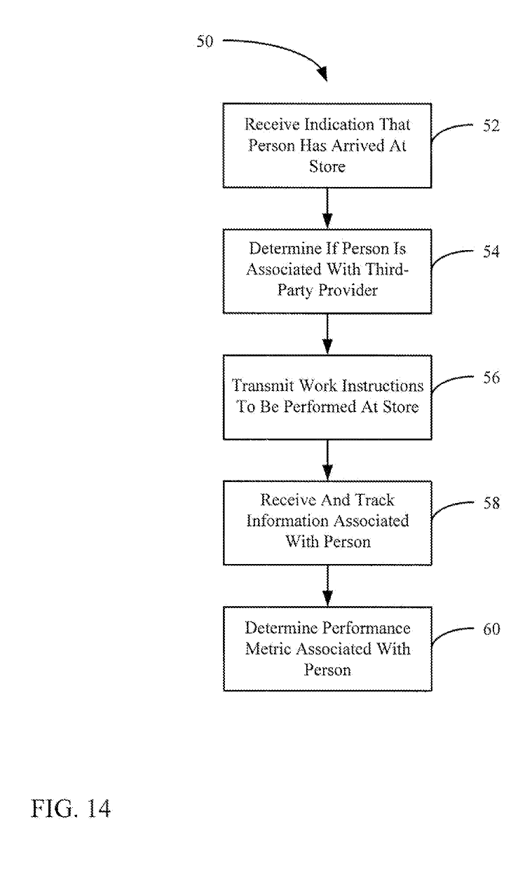

FIG. 14 illustrates various embodiments of a method 50. The method 50 may be may be utilized to manage third-party labor associated with one or more stores. According to various embodiments, the method 50 may be implemented by the system 10. Although the method 50 may be implemented by systems other than system 10, for purposes of simplicity, the method 50 will be described in the context of being implemented by the system 10.

Prior to the start of the process, information regarding the employees, workers, agents, etc. (third-party laborers) of various third-party providers associated with one or more stores are entered into the computing system 30 and are stored at storage device 34. Additionally, instructions regarding various tasks to be completed at the one or more stores by the third-party laborers are entered into the computing system 30 and are stored at storage device 34.

The process starts at block 52, where the system 10 receives an indication that a person has arrived at a given store. The indication may include any amount of data, including the name of the person, an identification associated with the person, the type of identification, the third-party the person is associated with, the time of arrival, etc. The indication may be received from the in-store computing system 12 of the given store or from a device other than the in-store computing system 12. For instances where the indication is received from the in-store computing system 12, the in-store computing system 12 becomes aware of the arrival of the person at the store based on information received via the input device 22 of the in-store computing system 12. As described hereinabove, the person may utilize any number of different type of input devices such as, for example, a card reader, a biometric input device, a keyboard, an optical scanning device, a touch screen, etc. to indicate his arrival at the store. For instances where the indication is received from a device other than the in-store computing system 12, the device (e.g., a mobile phone) is utilized by the person to indicate his arrival at the store.

From block 52, the process advances to block 54, where the authentication module 36 determines if the person is associated with a third-party provider. The authentication module 36 may make this determination by comparing the information received at block 52 with information stored at storage device 34. If the authentication module 36 determines that the person is not associated with a third-party provider, various warnings (sirens, flashing lights, announcements, etc.) may be activated at the store, and the process may end. However, if the authentication module 36 determines that the person is associated with a third-party provider, the process advances from block 54 to block 56. According to various embodiments, the authentication module 36 may also determine if the person is scheduled to be at the given store on that day, during that week, etc.

At block 56, the instruction module 38 communicates, to the in-store computing system 12, work instructions to be performed at the store by the person (third-party laborer). According to various embodiments, once the communicated work instructions are received by the in-store computing system 12, the work instructions are displayed on the display device 26 so the third-party laborer can view the work instructions. According to other embodiments, a hard copy of the work instructions may be printed out for use by the third-party laborer. The third-party laborer may utilize the input device 22 of the in-store computing system 12 to indicate the completion of the assigned tasks, as well as any in-store materials used to complete the tasks. This can be done after each task is completed or after all of the tasks are completed. It will be appreciated that the completed task information (as well as any other information) entered into the in-store computing system 12 by the third-party laborer may be communicated to the system 10, either in real time or periodically. Upon the completion of the assigned tasks, the third-party laborer may also utilize the input device 22 to indicate his departure from the store.

From block 56, the process advances to block 58, where the tracking module 40 receives and tracks the completed task information, the in-store materials information, and arrival/departure information from the in-store computing system 12. According to various embodiments, the tracking includes organizing the received information into relational databases, and storing the tracked information at storage device 34. The tracking module 40 may track the information in any number of different ways, including by company, by individual, by location, by time of day, etc.

From block 58, the process advances to block 60, where the performance module 42 determines performance metrics of the third-party laborers. According to various embodiments, the performance metrics are determined by comparing the performance of the respective third-party laborers with target performance metrics. The target performance metrics may be set by the store and/or the third-party providers. The performance metrics determined by the performance module 42 may be stored at the storage device 34 and tracked by the tracking module 40.

As described hereinabove, the system 10 may generate reports based on the various pieces of information stored at storage device 34, and the system 10 may communicate such reports to the stores and/or the third-party providers.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A system, comprising:
a computing device, wherein the computing device comprises a processor;
an authentication module communicably connected to the processor, wherein the authentication module is configured to authenticate that a person is associated with a third-party associated with a store;
an instruction module communicably connected to the processor, wherein the instruction module is configured to coordinate work instructions to be completed at the store; and
a tracking module communicably connected to the processor, wherein the tracking module is configured to track information associated with the person.

2. The system of claim 1, wherein the third-party is at least one of the following:
a manufacturer of a product sold in the store;
a service company;
a maintenance company; and
a security company.

3. The system of claim 1, wherein the information comprises at least one of the following:
a time of arrival at the store for the person;
a time of departure from the store for the person; and
a list of tasks completed at the store by the person.

4. The system of claim 1, further comprising a performance module communicably connected to the processor, wherein the performance module is configured to determine a performance metric of the person.

5. The system of claim 1, further comprising a reporting module communicably connected to the processor, wherein the reporting module is configured to prepare one or more reports.

6. The system of claim 5, wherein the reporting module is further configured to analyze information received by the system.

7. The system of claim 1, further comprising a financial module communicably connected to the processor, wherein the financial module is configured to determine an amount of revenue to be paid by a user of the system.

8. The system of claim 7, wherein the financial module is further configured to add a sum of money to a financial account.

9. A method, implemented at least in part by a computing device, the method comprising:
receiving, at the computing device, an indication that a person has arrived at a store;
determining if the person is associated with a third-party provider, wherein the determining is performed by the computing device;
transmitting work instructions to be performed at the store by the person, wherein the transmitting is performed by the computing device;
receiving, at the computing device, completed task information; and
tracking information associated with the person, wherein the tracking is performed by the computing device.

10. The method of claim 9, wherein determining if the person is associated with a third-party provider comprises determining if the person is associated with at least one of the following:
a manufacturer of a product sold in the store;
a service company;
a maintenance company; and
a security company.

11. The method of claim 9, wherein the determining comprises comparing information received with the indication to stored information accessible by the computing device.

12. The method of claim 9, further comprising determining if the person is scheduled to be at the store, wherein the determining is performed by the computing device.

13. The method of claim 9, wherein tracking the information comprises tracking at least one of the following:
an arrival time of the person at the store;
a departure time of the person from the store;
information associated with an in-store task completed by the person;
information associated with an in-store material used to complete the task; and
a performance metric associated with the person.

14. The method of claim 9, further comprising determining a performance metric associated with the person, wherein the determining is performed by the computing device.

15. The method of claim 14, wherein determining the performance metric comprises comparing a performance of the person with a target performance metric.
